(19) United States
(12) Patent Application Publication
(10) Pub. No.: US 2014/0147100 A1
(43) Pub. Date: May 29, 2014

(54) METHODS AND SYSTEMS OF EDITING AND DECODING A VIDEO FILE

(71) Applicants: Ilia Bakharov, Kiryat-Ono (IL); Vladimir Gorstein, Kfar-Saba (IL); Ira Dvir, Rishon-LeZion (IL)

(72) Inventors: Ilia Bakharov, Kiryat-Ono (IL); Vladimir Gorstein, Kfar-Saba (IL); Ira Dvir, Rishon-LeZion (IL)

(73) Assignee: Human Monitoring Ltd., Givat HaShlosha (IL)

(21) Appl. No.: 14/130,008

(22) PCT Filed: Jun. 28, 2012
(86) PCT No.: PCT/IL2012/050224

§ 371 Date: Dec. 30, 2013

Related U.S. Application Data
(60) Provisional application No. 61/502,897, filed on Jun. 30, 2011.

(51) Int. Cl. G11B 27/034; H04N 9/87

(52) U.S. Cl. CPC G11B 27/034; H04N 9/87
USPC 386/282; 386/278; 386/285

(57) ABSTRACT

A method of editing a video container format file. The method comprises displaying media content hosted in a video container format file stored in a segment of a memory of a client terminal, receiving editing instructions indicative of changes to the media content, adding and/or activating video editing objects with the editing instructions to the video container format file while the video container format file remains stored in the segment, and decoding the video editing objects and the media content. The decoding is performed by editing the media content according to said editing instructions in the video editing objects.

### FIELD AND BACKGROUND OF THE INVENTION

The present invention, in some embodiments thereof, relates to methods and systems for editing a video file and, more particularly, but not exclusively, to methods and systems for editing a video file which is stored in a memory of or accessed by a computing device.

Since the advent of the internet various video container formats have been developed. For example, MPEG (motion pictures experts group) is a standard promulgated by the International Standards Organization (ISO) to provide syntax for compactly representing digital video and audio signals. The syntax generally requires that a minimum number of rules be followed when bit streams are encoded so that a receiver of the encoded bit stream may unambiguously decode the received bit stream. As is well known to those skilled in the art, the bit stream includes a system component which includes metadata in addition to the video and audio components. Generally speaking, the system component contains information required for combining and synchronizing each of the video and audio components into a single bit stream. Specifically, the system component allows audio/video synchronization to be realized at the decoder.

Various techniques have been developed for editing video container format files. As an example of the techniques, there is a technique in which a moving picture file subjected to picture compression based on a standard such as MPEG (Moving Picture Experts Group) and recorded can be edited as the file is compressed. This technique extracts only moving picture data of an edition section from a video file and generates a new moving picture file from the extracted moving picture data. When the moving picture file has been subjected to picture compression based on MPEG, this edition section is edited by GOP (Group of Picture) so that one edited file is generated therefrom. When there are a plurality of edition sections, these edition sections are extracted from original moving picture files and connected to one another so that one moving picture file is generated (e.g. see JP-A-2003-319336).

Another example is described in United States Patent Application Pub. No. 20050271358 that describes provides a moving picture editing system including: a first apparatus which stores inputted video information as first and second encoded video files different from each other; and a second apparatus which can import the second encoded video file from the first apparatus; the first apparatus including: an encoding module which encodes the inputted video information so as to generate the first encoded video file high in bit rate; a recording module which records and stores the first encoded video file; a conversion module which converts the first encoded video file generated from the encoding module into the second encoded video file low in bit rate; an exporting module which exports the second encoded video file to the second apparatus; a reception module which receives an edition command from the outside; and a first edition module which imports the first encoded video file from the recording module, edits the first encoded video file and records the edited first encoded video file in the recording module in accordance with the edition command received by the reception module; the second apparatus including: an importing module which imports the second encoded video file exported from the exporting module of the first apparatus; a second edition module which edits the second encoded video file imported from the first apparatus by the importing module, in accordance with an edition command from the outside; a transmission module which transmits the edition command to the reception module of the first apparatus; and a module which decodes the second encoded video file edited by the second edition module and displays the decoded second encoded video file; wherein the first edition module in the first apparatus imports, from the recording module, the first encoded video file generated from the same video information as the second encoded video file is generated, and the first edition module edits the first encoded video file in accordance with the edition command from the second apparatus so that the edition process of the second encoded video file in the second apparatus is automatically reflected on the edition process of the first encoded video file.

### SUMMARY OF THE INVENTION

According to some embodiments of the present invention, there is provided a method of editing a video container format file. The method comprises displaying media content hosted in a video container format file stored in a segment of a memory of a client terminal, receiving media editing instructions indicative of changes to the media content, creating at least one video editing object according to the editing instructions, adding the at least one video editing object to the video container format file while the video container format file remains stored in the segment, decoding the at least one video editing object and the media content from the video container format file, where the decoding includes editing the media content according to the media editing instructions, and displaying the edited and decoded media content.

Optionally, the media editing instructions are received from a user of the client terminal via a man machine interface thereof.

Optionally, the media editing instructions are received from an imaging processing module analyzing the media content.

Optionally, the adding and the decoding is performed without changing the arrangement of video blocks in the segment.

Optionally, the client terminal is a camera device which captures the media content.

Optionally, the video container format file is an MPEG-4 file having at least one moov atom and at least one mdat atom, the decoding is performed without changing the at least one moov atom and the at least one mdat atom.

Optionally, the decoding is performed while the video container format file remain stored in the segment.

Optionally, the media editing instructions comprises a timeframe pertaining to the media content timeline; wherein the decoding comprises applying the editing instructions during the timeframe.

Optionally, the at least one video editing object comprises a visual content, the decoding comprises adding the visual content to the visual content; further comprising identifying a user selection of the visual content when displaying the media content and activating presenting a response to the user selection.

More optionally, the visual content comprises a member of a group consisting of an audio annotation pertaining to a scene depicted in the media content, metadata information pertaining to the media content, GPS coordinates indicative of the venue of the scene, at least one keyword describing the media content, at least one additional image associated with at least one region depicted in at least one frame of the media content, instructions for executing at least one of an applet and a widget, the instructions are associated with the at least one region, and a data extension pointer pointing to a memory address of descriptive data pertaining to the media content.

Optionally, the at least one video editing object comprises a hyperlink, the decoding comprises presenting an indication of the hyperlink to at least one frame of the media content; further comprising identifying a user selection of the indication when displaying the media content and browsing to the hyperlink in response to the user selection.

Optionally, the video container format of the video container format file is selected from a group consisting of 3GP, Advanced Systems Format (ASF), Audio Video Interleave (AVI), Microsoft Digital Video Recording (DVR-MS), Flash Video (FLV) (F4V), interchange file format (IFF), Matroska (MKV), Motion JPEG (M-JPEG), MJ2—Motion JPEG 2000 file format, QuickTime File Format, moving picture experts group (MPEG) program, MPEG-2 transport stream (MPEG-TS), MP4, RM, NUT, MXF, GXF, ratDVD, SVI, VOB, and DivX Media Format, and a derivative of any member of the group.

According to some embodiments of the present invention, there is provided a method of editing a video container format file. The method comprises displaying media content hosted with at least one video editing object in a video container format file stored in a segment of a memory of a client terminal, receiving media editing instructions indicative the editing media content from a user, activating or deactivating the at least one video editing object while the video container format file remains stored in the segment, and decoding the at least one activated video editing object and the media content from the video container format file. The decoding comprises editing the media content according to the at least one activated video editing object.

Optionally, each the video editing object comprises a flag, the activating or deactivating being performed by changing the flag.

According to some embodiments of the present invention, there is provided a method of decoding a video container format file. The method comprises receiving a media file storing a at least one video block in a video container format and at least one video editing object, using a decoder to decode editing instructions from the at least one video editing object, using a video decoder to decode media content from the at least one video block and to edit the media content according to the at least one video editing object, and outputting an output of the decoded and edited media content.

According to some embodiments of the present invention, there is provided an apparatus for generating a video container format file. The apparatus a memory which stores a video container format file having a video component, an audio component, and a system component, a user interface for receiving editing instructions pertaining to media content of the video container format file from a user, and an encoder which encodes the editing instructions in at least one video editing object and adds the at least one video editing object to the system component. The addition of the at least one video editing object does not change the arrangement or the storage location of the video component and the audio component in the memory.

According to some embodiments of the present invention, there is provided an apparatus for decoding a video container format file. The apparatus comprises a memory which stores a video container format file with media content and at least one video editing object indicative of editing instructions pertaining to the media content, a decoder which decodes the video container format file by editing the media content according to the editing instructions, and a display which presents the decoded and edited media content. The decoding is performed without creating a copy of the media content.

According to some embodiments of the present invention, there is provided a method of compressing a video container format file. The method comprises

receiving a media file storing a at least one video block in a video container format and at least one video editing object, using a decoder to decode editing instructions from the at least one video editing object, using a video decoder to decode media content from the at least one video block, reencoding the media file according to the at least one video editing object, and outputting an output of the reencoded media file.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method of locally editing video content which is stored in a video container format file without copying the video container format file and/or rearranging audio and/or video components thereof, according to some embodiments of the present invention;

FIG. 2 is a schematic illustration depicting a Moving Picture Experts Group (MPEG)-4 Part 14 (MP4) file with a video editing object section, according to some embodiments of the present invention;

FIG. 3 is a schematic illustration of an exemplary section, a header, which stores the video editing objects, according to some embodiments of the present invention;

FIG. 4 is a schematic illustration of a client terminal for generating a video container format file with editing instructions, according to some embodiments of the present invention;

FIG. 5 is a flowchart of a method of decoding a video container format file having a set video editing objects, to display a version of the video content stored therein edited according to the editing objects, according to some embodiments of the present invention; and

FIG. 6 is a schematic illustration of a client terminal for decoding a video container format file, according to some embodiments of the present invention.

### DESCRIPTION OF EMBODIMENTS OF THE INVENTION

The present invention, in some embodiments thereof, relates to methods and systems for editing a video file and, more particularly, but not exclusively, to methods and systems for editing a video file which is stored in a memory of or accessed by a computing device.

According to some embodiments of the present invention, there is provided a method of editing media content stored in a video container format file, such as an MPEG-4 file, by adding objects with editing instructions to the system component of the video container format file. This process allows efficiently editing media content on client terminals with limited computational power, limited bus capabilities, and/or limited memory space, such as cameras, cellular devices, and/or tablets without relying on a network connection. The method is based on allowing a user to view media content hosted in a video container format file that is stored in a segment of a memory of a client terminal and receiving media editing instructions indicative of changes to the media content therefrom. These media editing instructions are encoded into video editing objects which are added to the video container format file while the video container format file remains stored in the segment. Now, when the video container format file is decoded, for example for the presentation of the media content, the media content is edited according to the media editing instructions. The editing may be visual content to frames of the media content and/or changing the order of presenting video blocks that contain the media content, for example not presenting certain video blocks or altering their order.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

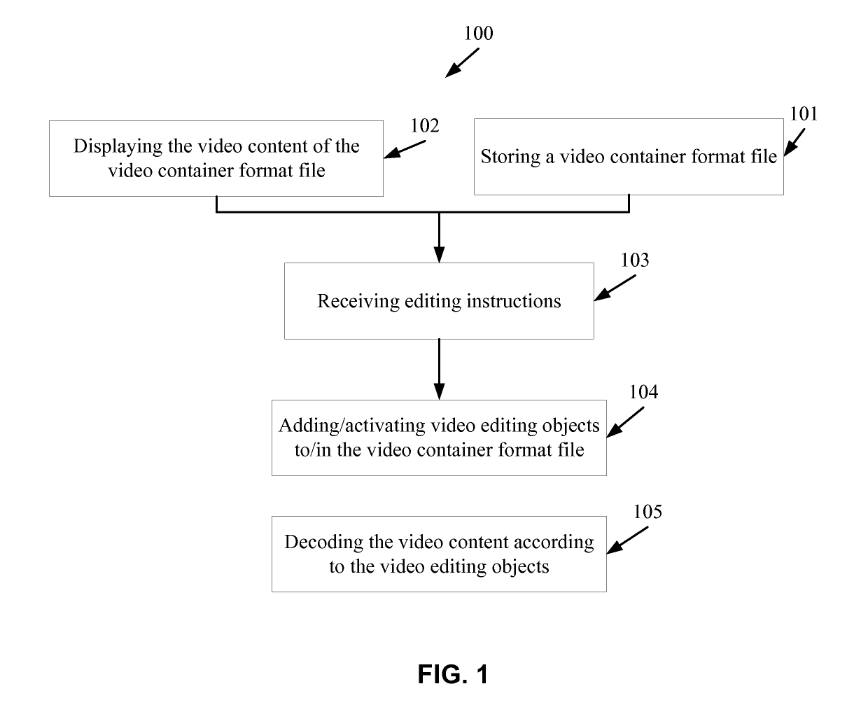

Reference is now made to FIG. 1, which is a flowchart 100 of a method 100 of locally editing media content, which is stored in a video container format file rearranging audio and/or video components thereof and optionally without creating copies thereof, according to some embodiments of the present invention. As used herein, media content may be any video content, audiovisual content, and/or audible content. As used herein, a video container format is a meta-file format having a specification which describes how data, which may be video data and metadata, are stored. Exemplary video container formats include 3GP, which is based on the ISO base media file format, Advanced Systems Format (ASF), Audio Video Interleave (AVI), Microsoft Digital Video Recording (DVR-MS), Flash Video (FLV) (F4V), interchange file format (IFF), Matroska (MKV), Motion JPEG (M-JPEG), MJ2—Motion JPEG 2000 file format, based on the ISO base media file format which is defined in MPEG-4 Part 12 and JPEG 2000 Part 12, QuickTime File Format, and moving picture experts group (MPEG) program stream, MPEG-2 transport stream (MPEG-TS), MP4, RM, NUT, MXF, GXF, ratDVD, SVI, VOB and DivX Media Format.

The method is optionally implemented by a client terminal, referred to as a device, such as a desktop computer, laptop, a Smartphone, a camera, an imager, and/or any device having a display and computing abilities. It should be noted that as the editing of the media content is performed locally in the storage of location of the hosting video container format file, the method 100 is, inter alia, useful for implementation on client terminals with low computational power and/or limited memory, such as handheld devices, for example Smartphones, tablets, and cameras. As the editing may be performed without changing the data structure of the hosting video container format file, for example without changing the moov and/or the mdat atoms in an MPEG-4 file, the computational complexity of the editing operation may be limited.

The method allows editing media content in a video container format file by encapsulating video editing objects therein. When the video container format file with the encapsulated video editing objects is decoded, visual data may be added to the media content, providing an interactive or variable user experience to a viewer and/or stimulate a number of her senses simultaneously. Additionally or alternatively, when the video container format file with the encapsulated video editing objects therein is decoded, media content that is manipulated locally without changing the arrangement of audio and/or video components in the hosting video container format file may be displayed. For example, the encapsulation allows embedding editing instructions, such as removing a block of the media content during the decoding thereof (i.e. skipping a number of traks to be played from the playing list in MPEG-4 files), adding an interlude between two video blocks (i.e. between the playing of two traks in MPEG-4 files), adding content to one or more frames of the media content, displaying a visual content, such as an image between two video blocks (i.e. between the playing of two traks in MPEG-4 files), changing the order of displaying the A/V blocks, and/or the like as further described below. For example, a video editing object may include a list of pointers to blocks such as traks, each tagged as deleted, for example by ‘0’, or not deleted, for example by ‘1’. In addition, this encapsulation increases the interoperability of various applications, such as social network applications, web browsers, file managers of an operating system, file mangers of image capturing devices, file sharing sites, search engines, and/or web-based email system services. A video container format file, which is added with such video editing object(s), may be searched for, identified, processed, tagged, and/or linked by any of these applications in a low computational complexity, for example as further described below.

First, as shown at 101, a video container format file, such as an MPEG-4 file, which hosts audio/visual content, such as home made video or a filmed scenes, is stored in a certain segment of a memory of a client terminal or any other computing unit, for example in internal storage of the client terminal, such as a flash memory drive, a disk driver and/or any other memory device. The certain segment may be a certain area in the memory of the client terminal or any other computing unit which for brevity are referred to herein interchangeably. Optionally, as shown at 102, the media content in the video container format file is displayed to allow a user to determine how she wants to edit it, for example as described below.

Now, as shown at 103, editing instructions are received from a user, for example via an editing user interface, such as a touch screen editing UI software module that is hosted on the client terminal and/or a module that automatically generates video editing objects, for example as described below. As shown at 104, the editing instructions are added to and/or activated in the video container format file so that the video and/or audio components of the media content, which are stored in the certain segment of the memory, do not change.

The editing instructions are optionally stored in video editing objects. Optionally, the video editing objects are added to or activated in a supplemental data block of the video container format file so that the arrangement or the size of video and/or audio components of the video container format file, for example the moov atom(s) and mdat atom(s) in an MP4 file, are not changed. Therefore, the video container format file remains in its storage location in the memory during and optionally after the addition/activation of video editing objects.

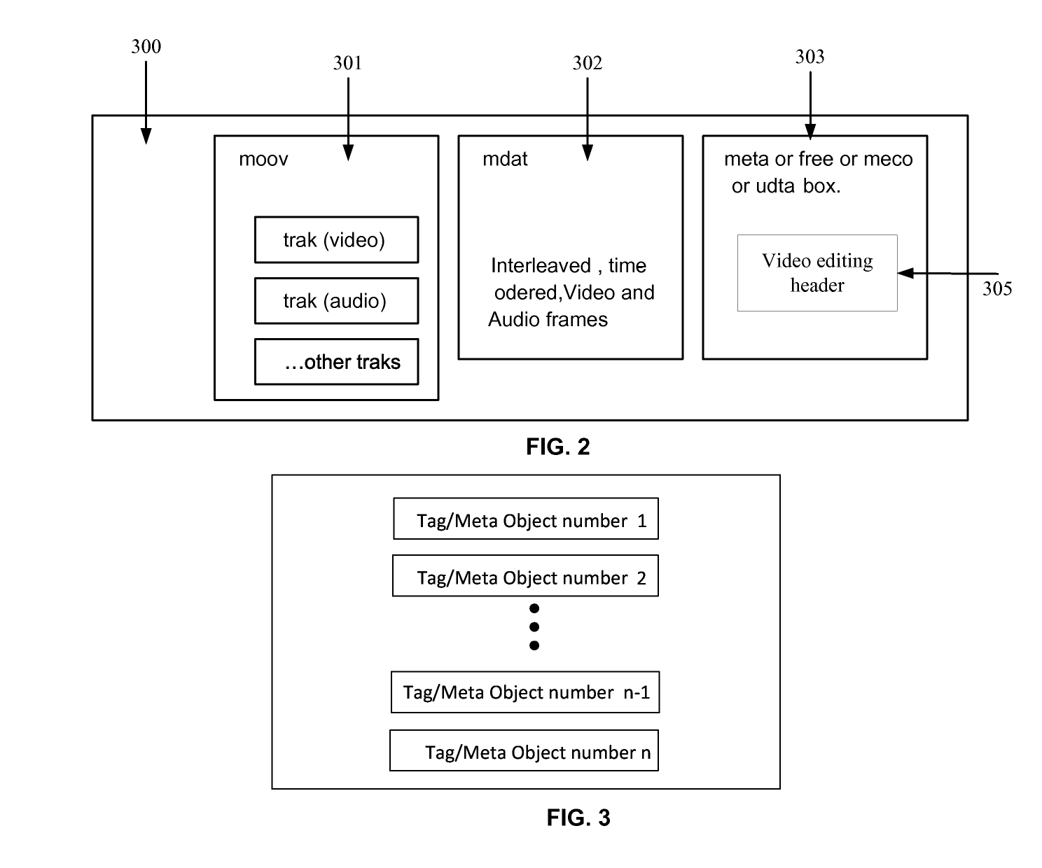

Optionally, a video editing object is optionally a container with a description represented in an extensible markup language (XML) format. The one or more video editing objects are optionally stored in a video editing object header of the video container format file. For example, reference is now also made to FIG. 2 which depicts a schematic illustration of components of an MP4 file 300 with a video editing object section 305. The MP4 file includes moov atom(s) 301, mdat atom(s) 302 and a system component, marked as a free atom 303, which hosts a video editing object header 305. As used herein, the free atom 303 may include the non mdat and non moov storage space.

Each video editing object, which is stored in the video container format file, receives a unique identification (ID), for example as shown at FIG. 3, which is a schematic illustration of an exemplary section, a header, which stores the video editing objects.

The addition and/or activation of video editing objects does not require the creation of a copy of any part of the media content and/or changing the data structure of audio and/or video objects. Optionally, the added and/or activated video editing objects are indicative of visual content and/or editing instructions. Each video editing object optionally includes visual content and/or editing instructions related to a certain timeframe of the media content.

Optionally, the activation of video editing objects is performed by adjusting the values of predefined video editing objects, which are stored in the video container format file. For example, each one of the predefined video editing objects has a flag that is indicative of the state of the respective predefined video editing object, for example ‘0’ is indicative of an active state and ‘1’ is indicative of a non active state. Editing the media content in such a video container format file requires no additional memory space and a minimal computational power. In such a manner, editing instructions can be added to a video container format file by a computing device with relatively low computing power and/or memory.

Optionally, the one or more video editing objects may be generated automatically, for example by a client terminal which manages the memory, for instance by an image processing module which analyzes the media content and/or selected, provided and/or generated by an operator of the client terminal which manages the memory hosting the video container format file. The automatically or manually generated video editing objects are added to the video container format file as described above.

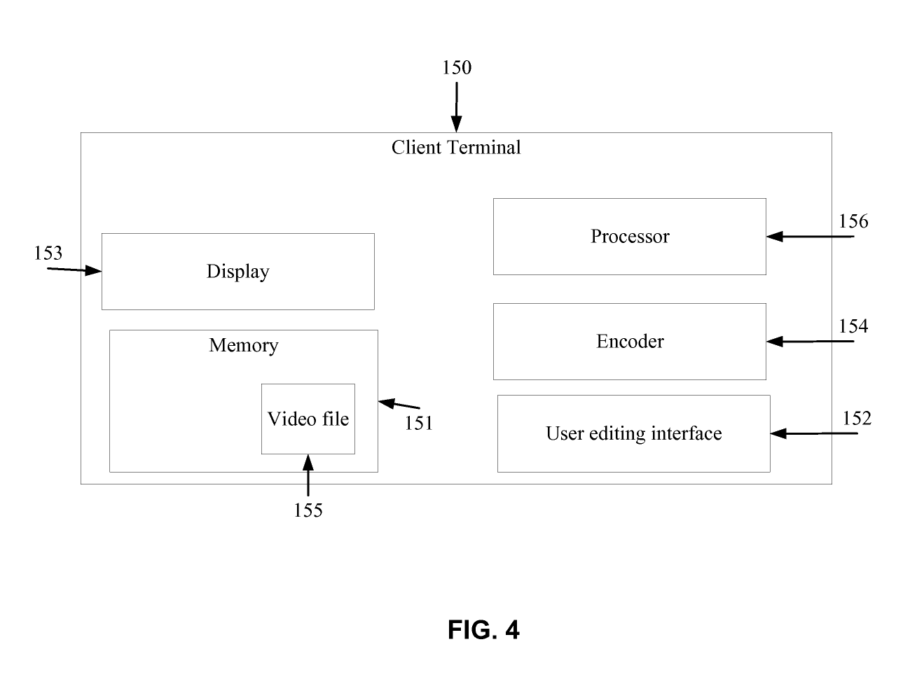

For example, reference is now made to FIG. 4, which is a schematic illustration of a client terminal 150 for generating a video container format file with editing instructions, according to some embodiments of the present invention. The client terminal 150 includes a memory 151 which stores a video container format file 155 with media content and a user editing interface 152 for receiving editing instructions from a user. The user editing interface 152 is optionally a video editing man machine interface that allows displaying the media content that is decoded in the video container format file 155 on a display 153 of the client terminal 151. For example, the user editing interface 152 is an app that is installed in the memory of the client terminal (not shown), which is optionally a Smartphone, a Smart TV, a tablet, or any app supporting device. In use, the user uses the user editing interface 152 to select the video container format file 155 and the app displays the media content on the screen 153 of the client terminal 150, for example as known in the art.

The user than selects content for adding to the media content and/or edit the media content, for example selects blocks which should not be displayed and/or change the order of the display of the blocks. The client terminal 151, optionally the app, further includes an encoder 154 which encodes editing instructions as one or more video editing objects, for example as described above and adds these video editing objects to the video container format file 155. This is optionally done without copying the video container format file 155 and/or rearranging the video and/or audio blocks thereof. The operations of the app are optionally implemented using a processor 156, such as the integrated processor of the client terminal 151.

Reference is now made, once again, to FIG. 1.

Now, the editing of media content in the video container format file is performed during the decoding of the video container format file, for example as shown at 105, to display the media content with the effect of the added and/or activated video editing object(s) thereon. In such a manner, the media content that is stored in the video container format file is actually edited during the decoding process.

For example, the video editing object(s) are comprises of certain links and/or graphical objects and optionally instructions indicative of a certain timeframe for the presentation thereof in the media content. In use, the video container format file is decoded so that the media content is displayed and during this certain timeframe the certain links and/or graphical and/or textual objects are decoded and displayed. According to another example, the video editing object includes editing instructions such as skipping one or more scenes, adding an interlude, replaying one or more scenes, reordering the display of a scene(s) and/or the like. In such an embodiment, the decoding of the video container format file includes displaying the media content after the manipulation thereof according to the editing instructions.

Optionally, the one or more video editing objects include links, such as uniform resource locators (URLs) or any pointer indicative of a document or information resource that is suitable for the World Wide Web and can be accessed through a web browser and displayed on a display of a stationary device or a mobile device that hosts the video container format file. In such an embodiment, the video editing object, which may be associated with a region in one or more frames of the media content, may allow a user which clicks or otherwise selects the region to be redirected to the linked document, optionally automatically. As used herein, a region may be an area of a frame and/or an element depicted in a frame.

Optionally, the one or more video editing objects include indicative textual data for allowing search engines to identify the generated media content by a word search, for example in response to a query. The indicative textual data may be used to identify people or objects, which are depicted in a certain scene in the media content. This data may be used by a social network tagging module, a searching and/or classification module of a device, such as a camera or a cellular phone, and image processing modules. The indicative textual data may include location data that allows a navigation means or a location based application to use the media content to depict or visually describe a location in a map and/or to classify or search for the video container format file according to a venue.

Optionally, the one or more video editing objects include a thumbnail for previewing a frame of the media content for example in a file manager, photo manipulation software, and/or a limited resources display. For example, the one or more objects may be defined according to an exchangeable image file format (EXIF) standard, material exchange format (MXF) standard, or any portion of an EXIF or MXF object.

Optionally, the one or more tagged objects include one or more audio sequences, for example audible annotations which describe the imaged scene or, audible tags which describes objects or elements in the imaged scene, a musical content to be played with the display of the media content at a certain time frame and/or an audible signature.

Optionally, the one or more objects include alpha compositing data, such as an alpha channel or any data indicative of a transparency level of some or all of the pixels of frames in the media content.

Optionally, the one or more objects include location information, such as global positioning system (GPS) coordinates of the venue at which the media content or a portion thereof were captured. Such data may be included in the EXIF data of the camera, or provided as an independent tag.

Optionally, a data associated with the location information is automatically identified and added to the one or more video editing objects. For example, a module for acquiring location based information is installed on a device implementing the method, for example an imaging device, such as a camera. The module accesses a database that associates between location information, such as GPS coordinates, and venues in their proximity. An example for such as a database is Google maps™, Wikihood™ or various transportation planners databases. Then, the module extracts the data or links, such as URLs, which are associated with the current location of the respective device. The extracted data and/or links are added, optionally together with the location information, to the one or more objects which are encapsulated in the video container format file. In such a manner, a media content that is taken in a certain location, such as a bar, a restaurant, a hotel, and/or a tourist venue, is stored in the video container format file with descriptive data, and/or links to such descriptive data, which are automatically extracted from a database, as described above. In another example, media content which is taken or otherwise inserted in a location, such as the Eiffel tower, is stored with links to a Wikipedia entry, links to video galleries which are related to the Eiffel tower, related points of interest and the like. Optionally, location based data, which is extracted as described above, is encoded as an audio sequence, for example by using a text to speech module, and added as an audio annotation or tag(s).

It should be noted that such video editing objects generates a video that is associated and linked to one or more WebPages or websites. In such a manner, a user who accesses the video container format file receives an infrastructure to access information thereabout, for example regarding a certain scene or a figure. Optionally, such video container format files may automatically associated with one or more location based services, allowing a user who uses the location based services to watch respective media content in response to location based information input.

Optionally, the one or more video editing objects include applets, such as outline applets, view applets, action bar applets, and editor applets, as well as other applets and widgets or any program which may be executed by a device presenting the media content. In such an embodiment, the video editing object, which may be associated with a region of one or more frames of the media content, may allow a user which clicks or otherwise selects the region to execute a certain code in parallel to the display of the one or more frames of the media content, and optionally to affect the displayed media content.

Optionally, the one or more video editing objects include text tags related to the media content and/or to one or more regions thereof. For example, a video editing object which includes text tags which describe objects in the media content and a map associating each one of the text tags with respective coordinates is received.

Optionally, the one or more video editing objects include one or more visual objects, such as video clips, graphic elements and/or still images. In such an embodiment, a visual object may be associated with an area in an image, for example with a region depicting a certain video editing object. In such an embodiment, the visual object may depict the associated region with more details, for example in higher resolution, from different angles, in different point in time, taken using other imaging devices and the like, In such a manner, a media content is provided with the ability to provide more visual information about various depicted regions may be formed. Visual objects, such as images and video sequences may be stored as linked files.

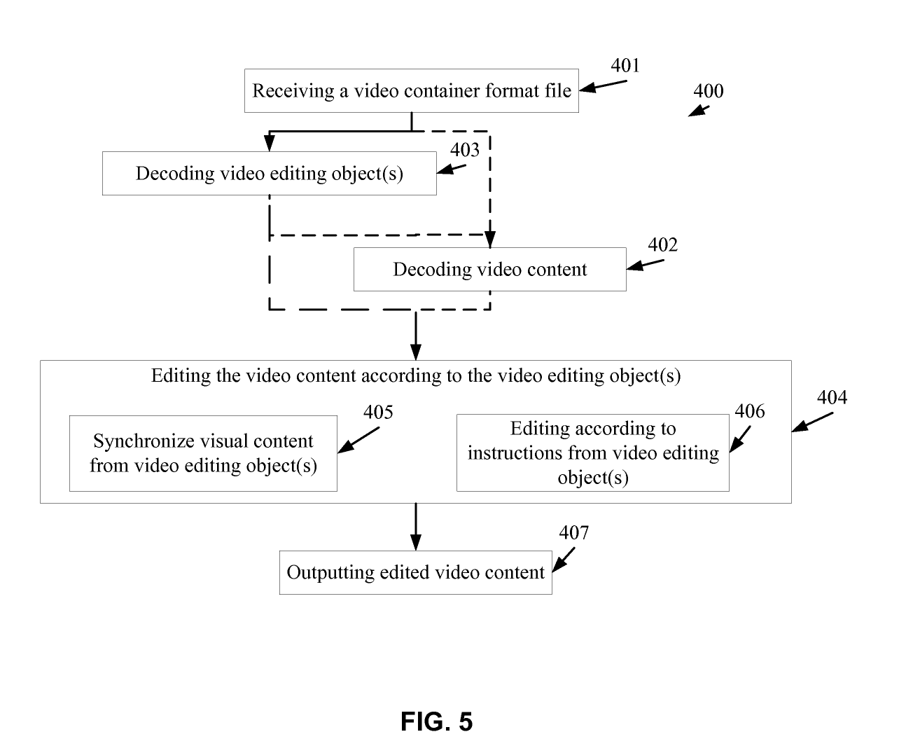

Reference is now made to FIG. 5, which is a flowchart of a method 400 of decoding a video container format file with video editing object(s), to display a version of the media content stored therein edited according to the video editing objects, according to some embodiments of the present invention.

First, as shown at 401 a video container format file is received. Then, as shown at 402, another media decoder, which is set according to the video container format, is used to decode the one or more objects from data contained in the video container format file, for example non video data or as another video sequence. Any of the aforementioned objects may be extracted from the media file, for example the EXIF object, the AlfaChannel object, the XMP object, the AudioTag object, the VideoTag object the TextTag object the Picture Tag object and/or the DataExtension object. The decoding may be performed by respective decoders, for example a text decoder, a data decoder, a graphic decoder and the like. The decoding process is clear in light of the afore-described encoding.

Then, as shown at 403, a video decoder of the video container format is used to decode at least some of media content from one or more video blocks contained in the video component of the video container format file, optionally according to the one or more decided objects. For example, when the video container format is MP4, the video decoder is set to decode the media content from the mdat atom, for example as described in MPEG standards, which are incorporated herein by reference. Optionally, the decoding is performed according to the video editing object(s) so that blocks which are not marked for playing are ignored. For example, in an MPEG-4 file, MOOV data is accessed according to the editing objects so that parts of the media content is decoded only if it is necessary. For example, an I frame is decoded only if it is part of a block which is marked for playing and/or part of an omitted part upon which the successive frames rely on.

Now, the media content is edited according to the video editing object(s), as shown at 404. Optionally, as shown at 405, the display of visual content stored in the video editing object(s) is synchronized with the media content. In such an embodiment, the respective timeframe is extracted from the video editing object(s). For example, the synchronizing includes associating or linking coordinates of frames and timeframes of the media content with respective video editing object(s), for example according to the instructions in the data structures stored in the metadata block. The synchronization is performed in the spatial, for example associating regions in frames with certain objects, and/or in the temporal dimension, for example associating periods in the time of presenting the visual objects. The synchronization may be performed automatically as an outcome of the aforementioned decoding and/or as a separate subsequent pre display stage. Optionally, the process depicted in FIG. 5 is used for a compacting process, wherein audio/video blocks are rearranged according to the video editing objects. For example, in MPEG-4, MOOV data is rearranged. Such a compacting process may be performed prior to or on the fly, while transmitting the file from one client terminal to another or when resources are not scarce.

Additionally or alternatively, as shown at 406, the order and/or timing of the display of blocks of the decoded media content is determined according to editing instructions in the video editing object(s). For example, certain video blocks are presented after other video blocks, certain video blocks are not played, and certain video blocks are played a number of times.

Now, as shown at 407, the decoded media content is outputted, for example as a video stream that allow the user to simultaneously watch the edited media content and/or the media content and additional data.

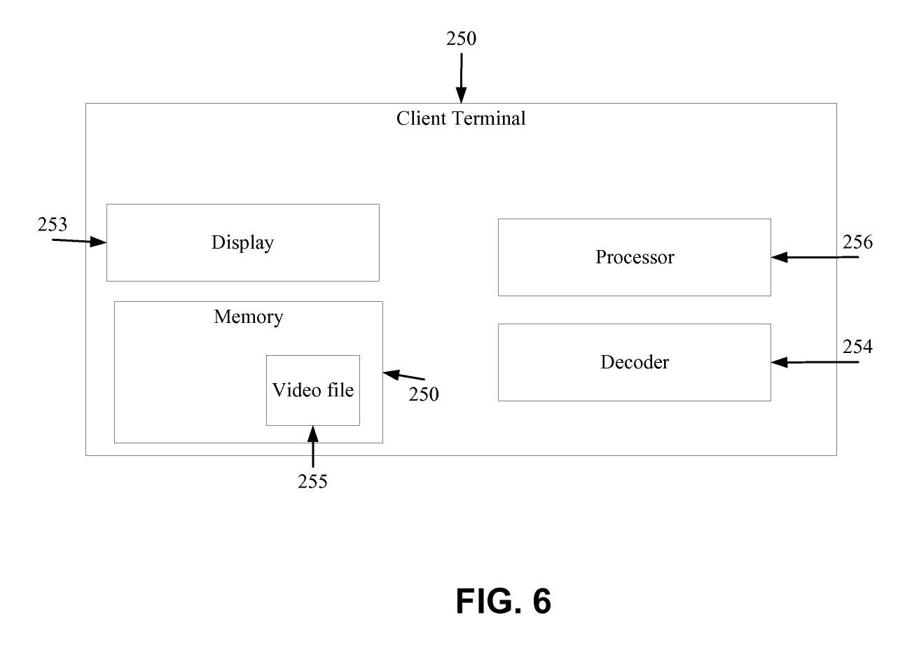

For example, reference is now made to FIG. 6, which is a schematic illustration of a client terminal 250 which decodes a video container format file with editing instructions, according to some embodiments of the present invention. The client terminal 250 includes a memory 251 which stores a video container format file 255 with media content and a display 253. The video container format file 255 includes one or more video editing objects with editing instructions, for example as described above. In use, the user may select the media content of the video container format file 255 for display. The client terminal 251, optionally an app which is installed thereon, includes a decoder 254 which decodes the media content according to the editing instructions in the video editing objects, for example as described above. This is optionally done without generating a copy of the video container format file 255 and/or rearranging the video and/or audio blocks thereof. The operations of the app are optionally implemented using a processor 256, such as the integrated processor of the client terminal 251.

It is expected that during the life of a patent maturing from this application many relevant systems and methods will be developed and the scope of the term computing unit, client terminal, memory, and network is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of editing a video container format file, comprising:
displaying media content hosted in a video container format file stored in a segment of a memory of a client terminal;
receiving media editing instructions indicative of changes to said media content;
creating at least one video editing object according to said editing instructions;
adding said at least one video editing object to said video container format file while said video container format file remains stored in said segment;
decoding said at least one video editing object and said media content from said video container format file, where said decoding includes editing said media content according to said media editing instructions; and
displaying said edited and decoded media content.

2. The method of claim 1, wherein said media editing instructions are received from a user of said client terminal via a man machine interface thereof.

3. The method of claim 1, wherein said media editing instructions are received from an imaging processing module analyzing said media content.

4. The method of claim 1, wherein said adding and said decoding is performed without changing the arrangement of video blocks in said segment.

5. The method of claim 1, wherein said client terminal is a camera device which captures said media content.

6. The method of claim 1, wherein said video container format file is an MPEG-4 file having at least one moov atom and at least one mdat atom, said decoding is performed without changing said at least one moov atom and said at least one mdat atom.

7. The method of claim 1, wherein said decoding is performed while said video container format file remain stored in said segment.

8. The method of claim 1, wherein said media editing instructions comprises a timeframe pertaining to said media content timeline; wherein said decoding comprises applying said editing instructions during said timeframe.

9. The method of claim 1, wherein said at least one video editing object comprises a visual content, said decoding comprises adding said visual content to said visual content; further comprising identifying a user selection of said visual content when displaying said media content and activating presenting a response to said user selection.

10. The method of claim 9, wherein said visual content comprises a member of a group consisting of an audio annotation pertaining to a scene depicted in said media content, metadata information pertaining to said media content, GPS coordinates indicative of the venue of said scene, at least one keyword describing said media content, at least one additional image associated with at least one region depicted in at least one frame of said media content, instructions for executing at least one of an applet and a widget, said instructions are associated with said at least one region, and a data extension pointer pointing to a memory address of descriptive data pertaining to said media content.

11. The method of claim 1, wherein said at least one video editing object comprises a hyperlink, said decoding comprises presenting an indication of said hyperlink to at least one frame of said media content; further comprising identifying a user selection of said indication when displaying said media content and browsing to said hyperlink in response to said user selection.

12. The method of claim 1, wherein the video container format of said video container format file is selected from a group consisting of 3GP, Advanced Systems Format (ASF), Audio Video Interleave (AVI), Microsoft Digital Video Recording (DVR-MS), Flash Video (FLV) (F4V), interchange file format (IFF), Matroska (MKV), Motion JPEG (M-JPEG), MJ2—Motion JPEG 2000 file format, QuickTime File Format, moving picture experts group (MPEG) program, MPEG-2 transport stream (MPEG-TS), MP4, RM, NUT, MXF, GXF, ratDVD, SVI, VOB, and DivX Media Format, and a derivative of any member of said group.

13. A method of editing a video container format file, comprising:
displaying media content hosted with at least one video editing object in a video container format file stored in a segment of a memory of a client terminal;
receiving media editing instructions indicative said editing media content from a user;
activating or deactivating said at least one video editing object while said video container format file remains stored in said segment; and
decoding said at least one activated video editing object and said media content from said video container format file;
wherein said decoding comprises editing said media content according to said at least one activated video editing object.

14. The method of claim 13, wherein each said video editing object comprises a flag, said activating or deactivating being performed by changing said flag.

15. A method of decoding a video container format file, comprising:
receiving a media file storing a at least one video block in a video container format and at least one video editing object;
using a decoder to decode editing instructions from said at least one video editing object;
using a video decoder to decode media content from said at least one video block and to edit said media content according to said at least one video editing object; and
outputting an output of said decoded and edited media content.

16. An apparatus for generating a video container format file, comprising:
a memory which stores a video container format file having a video component, an audio component, and a system component;
a user interface for receiving editing instructions pertaining to media content of said video container format file from a user; and
an encoder which encodes said editing instructions in at least one video editing object and adds said at least one video editing object to said system component;
wherein the addition of said at least one video editing object does not change the arrangement or the storage location of said video component and said audio component in said memory.

17. An apparatus for decoding a video container format file, comprising:
a memory which stores a video container format file with media content and at least one video editing object indicative of editing instructions pertaining to said media content;
a decoder which decodes said video container format file by editing said media content according to said editing instructions;
a display which presents said decoded and edited media content;
wherein the decoding is performed without creating a copy of said media content.

18. A method of compressing a video container format file, comprising:
receiving a media file storing a at least one video block in a video container format and at least one video editing object;
using a decoder to decode editing instructions from said at least one video editing object;
using a video decoder to decode media content from said at least one video block;
reencoding said media file according to said at least one video editing object; and
outputting an output of said reencoded media file.
